(19) United States
(12) Patent Application Publication
(10) Pub. No.: US 2015/0062301 A1
(43) Pub. Date: Mar. 5, 2015

(54) NON-CONTACT 3D HUMAN FEATURE DATA ACQUISITION SYSTEM AND METHOD

(71) Applicants: Yueh-Ling LIN, HSINCHU CITY (TW); MAO-JIUN WANG, HSINCHU CITY (TW); HSU-PIN WANG, HSINCHU CITY (TW)

(72) Inventors: Yueh-Ling LIN, HSINCHU CITY (TW); MAO-JIUN WANG, HSINCHU CITY (TW); HSU-PIN WANG, HSINCHU CITY (TW)

(73) Assignee: NATIONAL TSING HUA UNIVERSITY, HSINCHU CITY (TW)

(21) Appl. No.: 14/075,628

(22) Filed: Nov. 8, 2013

(30) Foreign Application Priority Data
Aug. 30, 2013 (TW) 102131210

(51) Int. Cl. G06T 7/00; G06K 9/46; H04N 13/02

(52) U.S. Cl. CPC G06T 7/0075; H04N 13/0203; H04N 13/0275; G06K 9/4671; G06K 2209/40; G06T 2207/10028; G06T 2207/30196; G06T 2207/10012
USPC 348/46

(57) ABSTRACT

A non-contact 3D human data acquisition system and method includes a depth-sensing camera used to acquire the front and back depth image data of static body of a test individual, and a human characteristic algorithmic processor electrically connected with the depth-sensing camera, so as to acquire the depth image data for subsequent processing. The human characteristic algorithmic processor includes a human depth data analysis module, a human sire measurement module, and a 3D human feature data acquisition module. The depth-sensing camera could be used to capture depth images, and the human characteristic algorithmic processor can be performed without contacting, with the human body or available in remote control. This allows one individual to rapidly and easily obtain important characteristic data of the human body, conduct 3D human body analysis, and collect important characteristic sizes, thus helping to set up statistical databases for further analysis, research, and other applications.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT Not applicable.

REFERENCE TO AN APPENDIX SUBMITTED ON COMPACT DISC Not applicable.

### BACKGROUND OF THE INVENTION

1. . Field of the Invention

The present invention relates to a 3D human data acquisition technology; and more particularly to an innovative non-contact 3D human data acquisition system and method which are designed to integrate image acquisition technology by depth-sensing camera and a characteristic algorithm for human depth data analysis.

2. Description of Related Art including Information Disclosed Under 37 CFR 1.97 and 37 CFR 1.98.

With the advancement of modern technologies, a 3D human body scanner can be used to acquire the relevant human sizes and establish the anthropometric data for applications in relevant fields (e.g.; ergonomics/human factor/garment industry).

Said 3D human body scanner is a bulky and expensive equipment that has shortcomings such as lack of movability and higher maintenance cost. Moreover, the test individuals must wear tight-fitting clothes with multiple markers labeled manually on the body before the scanning. In such case, there still exist such disadvantages as human errors occurring during marking points. So, such equipment is only suitable for some professionals and a few test individuals in a limited group of people.

Thus, to solve the aforementioned problems, it would be an advancement if providing an efficient method that can significantly enhance the performance.

Therefore, the inventor has provided the present invention for deliberate design and practical evaluation from years of experience in the production, development, and design of related products.

### BRIEF SUMMARY OF THE INVENTION

The present invention enables users to capture depth images through the depth-sensing camera without directly contacting with the human body or available in remote control. With the useful method of the human characteristic algorithmic processor and means, important characteristic data of the human body can be rapidly acquired to conduct 3D human body analysis and collect important human body's characteristic sizes, thus helping to set up various statistical databases for further analysis, research, and other applications. This innovative technology of the present invention could thoroughly eliminate the shortcomings of the typical human body scanner such as: high maintenance cost and lack of movability as well as time-consuming in labeling points manually. Through repetitive test runs, the present invention permits to acquire accurate human characteristic data, thus not only reducing the human error but also accelerating the collection of human size measurement. Hence, the innovative technology of the present invention could resolve the manpower and cost problems in restructuring human database, realizing extensive human size data and statistics in a broad range (e.g.: regional human size statistics by the governmental bodies). In summary, the present invention could markedly reduce the cost in human data acquisition, realize higher movability of devices, and improve the working efficiency with high performance.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 is a perspective view of the preferred embodiment of the present invention.

FIG. 2 is a schematic view 1 of the present invention from human data acquisition to human characteristic algorithmic process.

FIG. 3 is a schematic view 2 of the present invention from human data acquisition to human characteristic algorithmic process.

FIG. 4 is a schematic view 3 of the present invention from human data acquisition to human characteristic algorithmic process.

FIG. 5 is a text block chart of the present invention showing the operating procedures.

FIG. 6 is a schematic view of the present invention wherein the virtual reality software technology could be developed into virtual fitting.

### DETAILED DESCRIPTION OF THE INVENTION

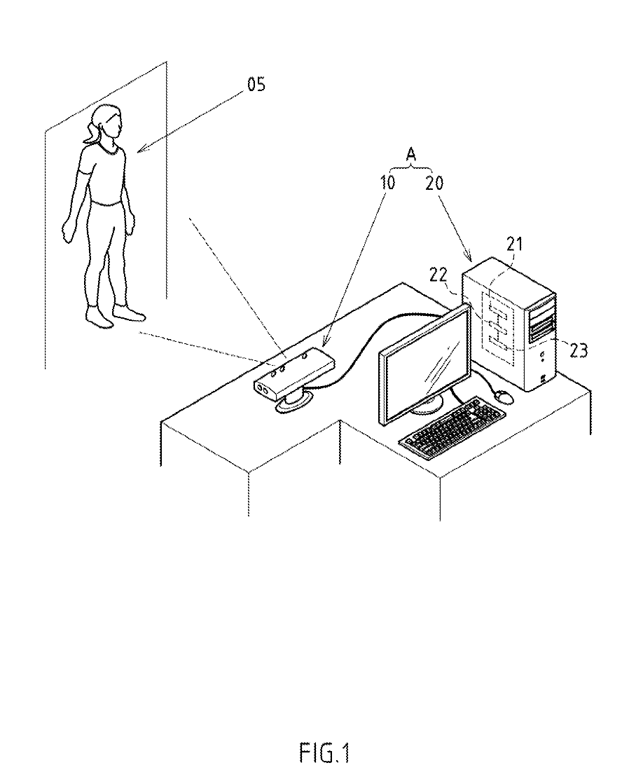

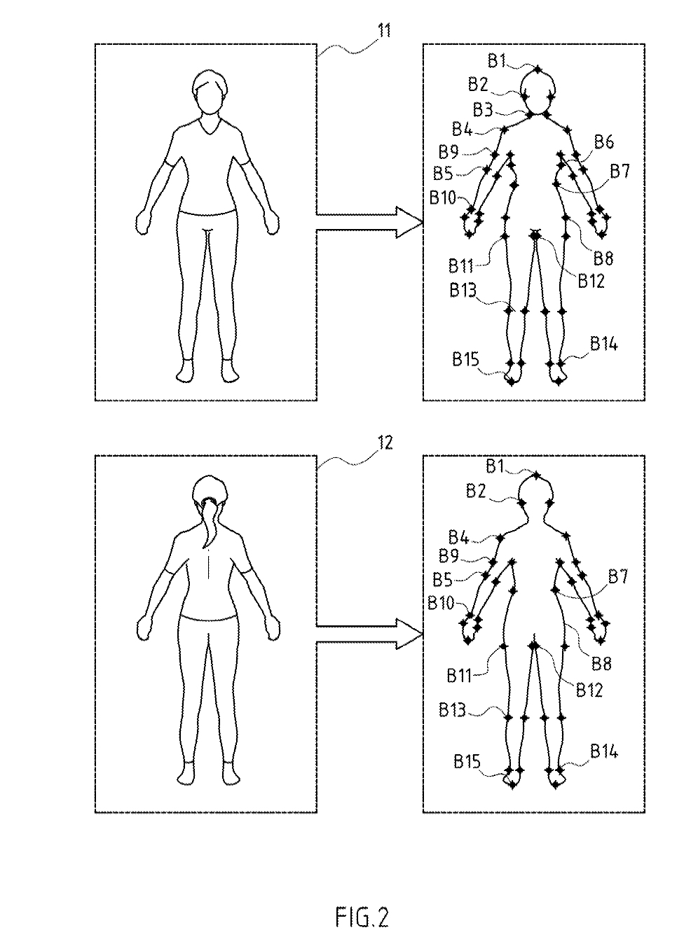

FIGS. 1-2 depict preferred embodiments of the non-contact 3D human data acquisition system of the present invention, which, however, are provided for only explanatory objective.

Said non-contact 3D human data acquisition system A comprises a depth-sensing camera 10 (Kinect), used to acquire the front and back depth image data 11, 12 from the static body of a test individual 05 (shown in FIG. 2).

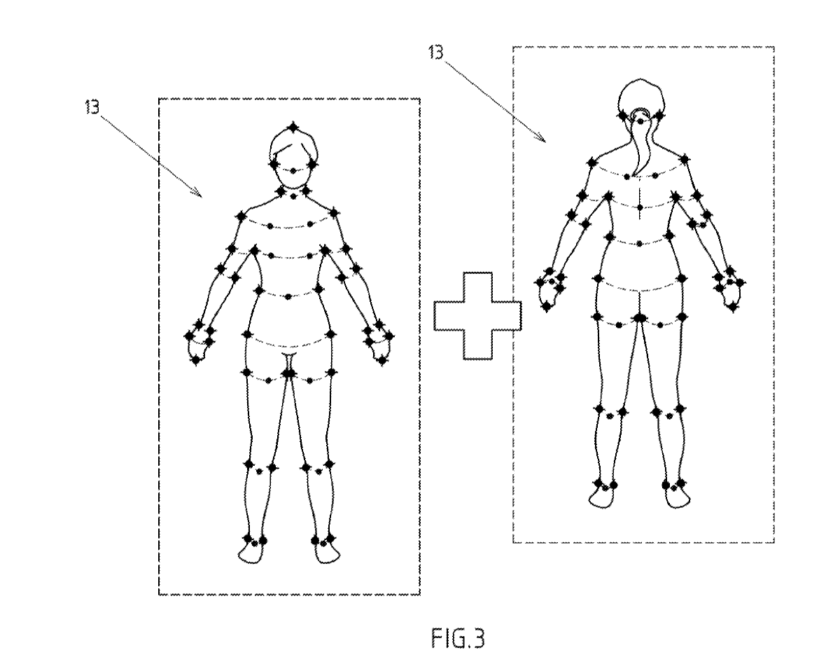

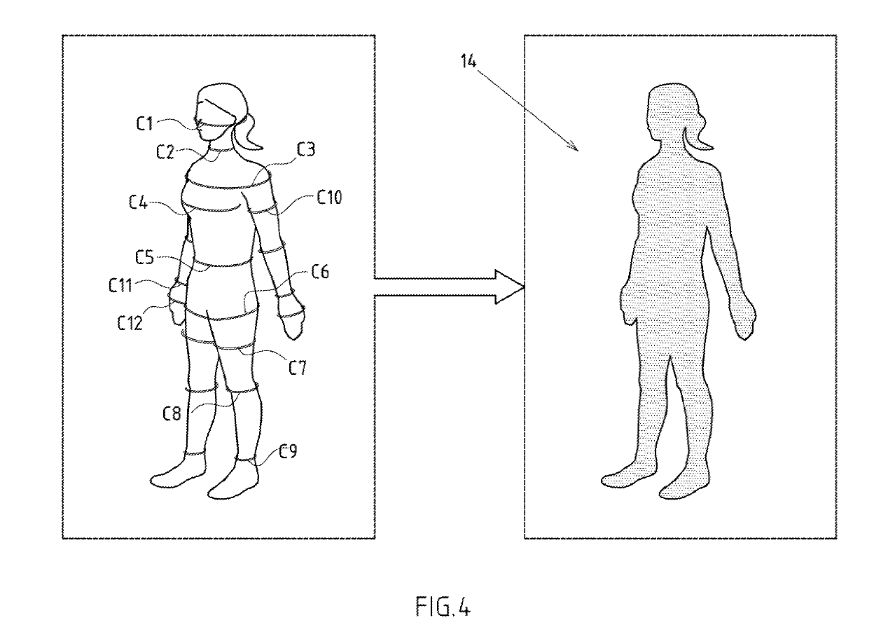

A human characteristic algorithmic processor 20 is electrically connected with the depth-sensing camera 10 (note: not limited to wired or wireless signal transmission state), so as to acquire the front and back depth image data 11, 12 by the depth-sensing camera 10 for subsequent processing. Said human characteristic algorithmic processor 20 comprises of: a human depth data analysis module 21, which is used to divide the acquired front and back depth image data 11, 12 of the human body into x, y, and z coordinate sequences according to the coordinate axis in 3D space, and then detect the differences among the coordinate sequences to extract multiple key feature points on the human body. When the arrangement of the coordinate sequence changes from increasing arrangement to decreasing arrangement or vice versa, the turning points between two different arrangements are taken as the positions of key feature points on the human body (shown in FIG. 2); a human size measurement module 22, which is used to obtain the relevant human sizes of said key feature points by calculating the human size circumference via radian distance, and the relevant human sizes are collected as the important characteristic sizes on the human body (shown in FIG. 4); a 3D human feature data acquisition module 23, which is used to arrange the depth image data by aligning the point data across the human cross section to replace the front and back overlaps; and then calibrate all the acquired feature points to smoothly rebuild a 3D human model 14 (shown in FIG. 4) according to the important characteristic sizes on the human body 13 (shown in FIG. 3).

Based on the design and technical features of above-specified non-contact 3D human data acquisition system, the depth-sensing camera 10 can be used to capture depth images, and the human characteristic algorithmic processor 20 can be performed without contacting with the human body or available in remote control. This allows one individual to rapidly and easily obtain important characteristic data of human body, conduct 3D human body analysis, and collect important human body's characteristic sizes, thus helping to set up various statistical databases for further analysis, research, and other applications.

Referring to FIG. 2, the human body's key feature points obtained by the human depth data analysis module 21 include: vertex point B1, head point B2, neck point B3, shoulder point B4, lateral elbow point B5, breast point B6, waist point B7, buttock point B8, upper arm point B9, wrist point B10, lateral thigh point B11, crotch point B12, knee point B13, ankle point B14, and pelma point B15.

Referring to FIG. 4, the human body's key characteristic sizes obtained by the human size measurement module include: head circumference C1, neck circumference C2, shoulder perimeter C3, breast circumference C4, waist circumference C5, buttock circumference C6, thigh circumference C7, knee circumference C8, ankle circumference C9, upper arm circumference C10, wrist perimeter C11, and hand perimeter C12.

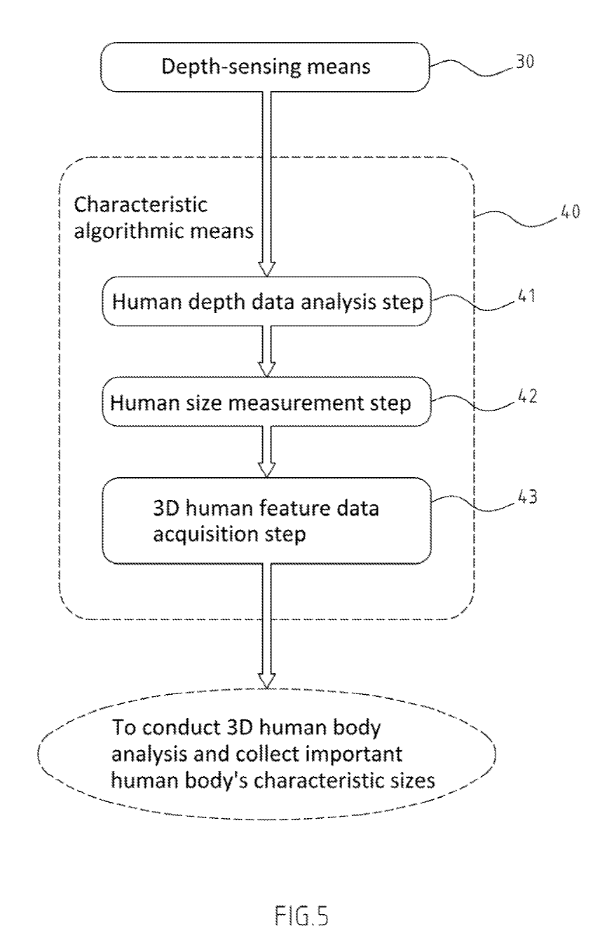

Next, the non-contact 3D human feature data acquisition method of the present invention comprises: (as shown in FIG. 5) a depth-sensing means 30 is used to capture the front and back depth image data of static body of a test individual a human characteristic algorithmic means 40 is used for subsequent processing of said depth image data. Said characteristic algorithmic means 40 comprises: a human depth data analysis step 41, a human size measurement step 42; and a 3D human characteristic data acquisition step 43.

The human depth data analysis step 41 is used to divide the acquired front and back depth image data of the human body into x, y, and z coordinate sequences according to the coordinate axis in 3D space, and then detect the differences among coordinate sequences to extract multiple key feature points on the human body. When the arrangement of the coordinate sequence changes from increasing arrangement to decreasing arrangement or vice versa, the turning points between two different arrangements are taken as the positions of key feature points on the human body (shown in FIG. 2).

Human size measurement step 42 is used to obtain the relevant human sizes of said key feature points by calculating the human size circumference via radian distance, and the relevant human sizes are collected as the important characteristic sizes on the human body (shown in FIG. 4),

3D human feature data acquisition step 43 is used to arrange the depth image data by aligning the point data across the human cross section to replace the front and back overlaps, and then calibrate all the acquired feature points to smoothly rebuild a 3D human model 14 (shown in FIG. 4) according to the important characteristic sizes on the human body 13 (shown in FIG. 3).

With this design, the depth-sensing camera 10 could be used to capture depth images, and the human characteristic algorithmic processor 20 can be performed without contacting with the human body or available in remote control. This allows one individual to rapidly and easily obtain important characteristic data of the human body, conduct 3D human body analysis, and collect important human body's characteristic sizes, thus helping to set up various statistical databases for further analysis, research, and other applications.

Of which, in the human depth data analysis step 41, the human body's key feature points include: vertex, wrist, armpit, crotch, and pelma points could be extracted from the turning, points of x-axis coordinate sequence; while the other human body's key feature points include: head, neck, hand, crotch, and waist points could also be extracted from the turning points of y-axis coordinate sequence.

Of which, in the human depth data analysis step 41, the key feature points of the whole body, including: vertex point B1, head point B2, neck point B3, shoulder point B4, lateral elbow point B5, breast point B6, waist point B7, buttock point B8, upper arm point B9, wrist point B10, lateral thigh point B11, crotch point B12, knee point B13, ankle point B14, and pelma point B15 (shown in FIG. 2), could be obtained from the difference among the coordinate sequences.

Of which, the human body's key characteristic sizes obtained by the human size measurement step 42 include: head circumference C1, neck circumference C2, shoulder perimeter C3, breast circumference C4, waist circumference C5, buttock circumference C6, thigh circumference C7, knee circumference C8, ankle circumference C9, upper arm circumference C10, wrist perimeter C11, and hand perimeter C12 (shown in FIG. 4).

The depth-sensing camera 10 (Kinect) referred to in the present invention is currently available in the market. Such depth-sensing camera can capture color images, 3D depth images and audio signals. It is often equipped with three lenses, of which the central len is commonly used in RGB color camera, and the lens at both sides are 3D depth sensors composed of IR emitter and ER CMOS camera. Currently, such a depth-sensing camera is generally used in E-games to detect the behavior of players. This is the first time for applying such a device for non-contact 3D human feature data acquisition.

The “non-contact 3D human feature data acquisition system and method” disclosed in the present invention could be used in the following applications:

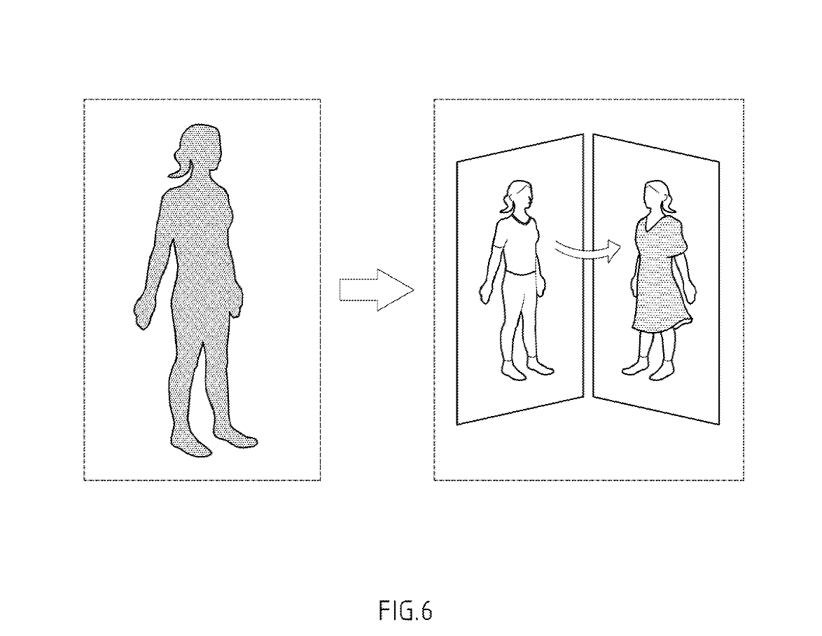

On-line clothes shopping: The present invention enables one individual to analyze the human body's depth data and obtain relevant human sizes, so it can be used for on-line clothes selection referring to the patterns, color, and sizes. If virtual reality software technology is further incorporated into virtual fitting (shown in FIG. 6), it is possible to expand virtual clothes marketing channel through virtual fitting technology. On the other hand, non-contact photographic technology is used to capture the human size, allowing for further analysis of the human body shape, contributing to classification of finished clothes in the garment industry.

Clothing design: The human size measurement data obtained by the present invention could be referenced by the clothing designer, helping to make customized products in the garment industry, on-line clothes shopping and fashion industry. Additionally, with the help of non-contact human size acquisition technology, it is helpful to build human body's measurement database for product evaluation in ergonomics, thus facilitating the relevant design of products and clothes by the clothing designers.

National research institutions: The non-contact 3D human feature data acquisition system and method disclosed in the present invention could be used to collect the human body's measurement data across the nation, but also help relevant units to establish human body's measurement database, and clothing sizing system, and virtual fitting system, thus providing a further insight into the clothing preference of general public as well as the distribution in term of ages and gender.

We claim:

1. A non-contact 3D human data acquisition system comprises: a depth-sensing camera used to acquire the front and back depth image data of static body of a test individual; a human characteristic algorithmic processor electrically connected with the depth-sensing camera, so as to acquire the front and back depth image data by the depth-sensing camera for subsequent processing; said human characteristic algorithmic processor comprises of a human depth data analysis module, which is used to divide the acquired front and back depth image data of the human body into x, y, and z coordinate sequences according to the coordinate axis in 3D space, and then detect the difference among the coordinate sequences to extract multiple key feature points on the human body. When the arrangement of the coordinate sequence changes twin increasing arrangement to decreasing arrangement or vice versa, the turning points between two different arrangements are taken as the positions of key feature points on the human body; a human size measurement module, which is used to obtain the relevant human sizes of said key feature points by calculating, the human size circumference via radian distance, and the relevant human sizes are collected as the important characteristic sizes on the human body; and a 1D human feature data acquisition module, which is used to arrange the depth image data by aligning the point data across the human cross section to replace the front and back overlaps, and then to calibrate all the acquired feature points to smoothly rebuild a 3D human model; the depth-sensing camera can be used to capture depth images, and the human characteristic algorithmic processor can be performed without contacting with the human body or available in remote control; this allows one individual to rapidly and easily obtain important characteristic data of the human body, conduct 3D human body analysis, and collect important characteristic sizes, thus helping to set up various statistical databases for further analysis, research, and other applications.

2. The system defined in claim 1, wherein the human body's key feature points obtained by the human depth data analysis module include: vertex point, head point, neck point, shoulder point, lateral elbow point, breast point, waist point, buttock point, upper arm point, wrist point, lateral thigh point, crotch point, knee point, ankle point, and pelma point.

3. The system defined in claim 1, wherein the human body's key characteristic sizes obtained by the human size measurement module include: head circumference, neck circumference, shoulder perimeter, breast circumference, waist circumference, buttock circumference, thigh circumference, knee circumference, ankle circumference, upper arm circumference, wrist perimeter, and hand perimeter.

4. A non-contact 3D human data acquisition method comprises: a depth-sensing means is used to capture the front and back depth image data of static body of a test individual; and a human characteristic algorithmic means is used for subsequent processing of said depth image data said human characteristic, algorithmic means comprises:
a human depth data analysis step, which is used to divide the front and back depth image data of the human body into x, y, and z coordinate sequences according to the coordinate axis in 3D space, and then detect the differences among coordinate sequences to extract multiple key feature points on the human body. When the arrangement of the coordinate sequence changes from increasing arrangement to decreasing arrangement or vice versa, the turning, points between two different arrangements are taken as the positions of key feature points on the human body;
a human size measurement step, which is used to obtain the relevant human sizes of said key feature points by calculating the human size circumference via radian distance, and the relevant human sizes are collected as the important characteristic sizes on the human body;
a 3D human feature data acquisition step, which is used to arrange the depth image data by aligning the point data across the human cross section to replace the front and back overlaps, and then calibrate all the acquired feature points to smoothly rebuild a 3D human model according to the important characteristic sizes on the human body;
the depth-sensing means could be used to capture depth images, and the human characteristic algorithmic processor can be performed without contacting with the human body or available in remote control; this allows one individual to rapidly and easily obtain important characteristic data of the human body, conduct 3D human body analysis, and collect important characteristic sizes, thus helping to set up various statistical databases for further analysis, research, and other applications.

5. The method defined in claim 4, wherein the human body's key feature points include:
vertex, wrist, armpit, crotch, and pelma points could be extracted from the turning points of x-axis coordinate sequence in the human depth data analysis step; while the other human body's key feature points include: bead, neck, band, crotch, and waist points could also be extracted from the turning points of y-axis coordinate sequence.

6. The method defined in claim 4, wherein the key feature points of the whole body, including: vertex point, headpoint, neck point, shoulder point, lateral elbow point, breast point, waist point, buttock point, upper arm point, wrist point, lateral thigh point, crotch point, knee point, ankle point, and pelma point, could be obtained from the difference among the coordinate sequences in the human depth data analysis step.

7. The method defined in claim 4, wherein the human body's key characteristic sizes obtained by the human size measurement step include: head circumference, neck circumference, shoulder perimeter, breast circumference, waist circumference, buttock circumference, thigh circumference, knee circumference, ankle circumference, upper arm circumference, wrist perimeter, and hand perimeter.
